(19) United States
(12) Patent Application Publication
(10) Pub. No.: US 2006/0114107 A1
(43) Pub. Date: Jun. 1, 2006

(54) Apparatus and method for estimating tire life

(76) Inventors: Sang Kook Kim, Icheon-si (KR); Dong Pil Chun, Icheon-si (KR); Dae Hyuk Kwon, Icheon-si (KR); Sang Hoon Choi, Icheon-si (KR); Heu Kyong Na, Icheon-si (KR); Won Jo Lee, Icheon-si (KR)

Correspondence Address: PARK LAW FIRM, 3255 WILSHIRE BLVD, SUITE 1110, LOS ANGELES, CA, 90010, US

(21) Appl. No.: 11/259,591

(22) Filed: Oct. 26, 2005

(30) Foreign Application Priority Data
Nov. 3, 2004 (KR) 10-2004-89006

(51) Int. Cl. B60Q 1/00; B60C 23/02; G01M 17/00

(52) U.S. Cl. 340/457; 340/442; 701/29

(57) ABSTRACT

An apparatus and method for estimating a tire life is provided. The apparatus includes a transmitter for storing tire position identification information, measuring and transmitting an internal pressure and temperature together with the tire position identification information; a receiver for detecting and comparing the tire position identification information and the internal pressure and temperature, with tire replacement temperature reference value and pressure reference value, and if any one of the internal pressure and temperature is greater than the tire replacement temperature reference value and pressure reference value, generating a warning signal for informing of tire replacement; and a warning unit for receiving the warning signal and warning a driver.

### BACKGROUND OF THE INVENTION

1. Field of the Invention

The present invention relates to an apparatus and method for estimating a tire life, and more particularly, to an apparatus and method for estimating a tire life, for informing of a replacement time of a tire depending on a variation of an internal pressure and temperature of the tire.

2. Description of the Related Art

In general, a vehicle tire is comprised of six parts of a tread, a shoulder, a sidewall, a belt, a carcass, and a bead. Since the tread is in direct contact with a road surface, it is formed of a tight rubber not well abraded, and has a tread pattern carved on its ground contact surface to enable a vehicle to have a function of keeping a direction, a cornering force, a performance of maintenance on a road surface, and a performance of brake. The carcass being a frame of a tire can be formed to support a car weight and sufficiently endure a continuous bending motion, and has cords overlapped. The carcass employed a cotton cord before, but at present, employs the cord such as rayon, nylon, polyester, and Kevlar and also employs a steel cord obtained by twisting a very thin iron wire. In general, the cord is bias adhered (bias tire), but in recent years, a radial fly tire having the cord adhered in a fan shape is being more manufactured and used for the vehicle. The bead being a backbone of the tire has an end wound at an end of the cord used for the carcass. Since the bead is fixed to a rim of a wheel, it is reinforced using tens of piano wires. The shoulder refers to a portion ranged from an edge of the tread to a top of the sidewall. The shoulder protects the carcass and concurrently, emits a heat generated in running. The sidewall refers to a rubber layer ranged from a bottom of the shoulder to the bead, and protects the internal carcass. The belt strongly binds the tread and the carcass, and enhances a rigidity of the tread.

A tire replacement time of the car, that is, a tire life is determined by user's checking with his/her naked eyes an abrasion line printed at a boundary of the tread and the shoulder or between the tread patterns.

As described above, in a conventional art, there is a drawback in that since the user checks the replacement time of the tire only with the naked eyes in order to determine the replacement time of the tire, there are many cases where the tire is apt to be used with its replacement time lapsing, and when the tire is used with its replacement time lapsing, there is a danger of causing an accident due to the vehicle sliding on the road surface.

### SUMMARY OF THE INVENTION

Accordingly, the present invention is directed to an apparatus and method for estimating a tire life that substantially overcomes one or more of the limitations and disadvantages of the conventional art.

One object of the present invention is to provide an apparatus and method for estimating a tire life, for detecting a variation of an internal pressure and temperature of a tire, and estimating and informing of a replacement cycle based on abrasion and use of the tire.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided an apparatus for estimating a tire life, the apparatus including: a transmitter for storing tire position identification information, measuring an internal pressure of a tire resulting from running of a vehicle and an internal temperature of the tire resulting from a tire friction with a road surface, and transmitting the measured internal pressure and temperature together with the tire position identification information; a receiver for storing tire replacement temperature reference value and pressure reference value, detecting and comparing the tire position identification information and the internal pressure and temperature received from the transmitter, with the tire replacement temperature reference value and pressure reference value, and if any one of the tire internal pressure and temperature is greater than the tire replacement temperature reference value and pressure reference value, generating a warning signal for informing of tire replacement; and a warning unit for receiving the warning signal and warning a driver.

In another aspect of the present invention, there is provided an apparatus for estimating a tire life, the apparatus including: a transmitter for storing tire position identification information, measuring an internal pressure of a tire resulting from running of a vehicle and an internal temperature of the tire resulting from a tire friction with a road⁻ surface, generating temperature and pressure measurement data having the tire position identification information and the measured pressure and temperature, and loading and transmitting the generated temperature and pressure measurement data on a wireless signal; a receiver for storing tire replacement temperature reference value and pressure reference value, detecting the temperature and pressure measurement data from the wireless signal, detecting the tire position identification information and the internal pressure and temperature from the wireless signal, calculating an instantaneous temperature slope and an instantaneous pressure value, comparing the calculated instantaneous temperature slope and instantaneous pressure value with the tire replacement temperature reference value and pressure reference value, respectively, and if any one of the calculated instantaneous temperature slope and instantaneous pressure value is greater than the tire replacement temperature reference value and pressure reference value, generating a warning signal for informing of tire replacement; and a warning unit for receiving the warning signal and warning a driver.

In a further aspect of the present invention, there is provided a method for estimating a tire life in a tire-life estimating apparatus having a transmitter having a transmission storage unit for storing tire position identification information, a receiver having a storage unit for storing tire replacement temperature reference value and pressure reference value, and a warning unit for warning a replacement time of a tire, the method including the steps of: in the transmitter, measuring an internal pressure of a tire resulting from running of a vehicle and an internal temperature of the tire resulting from a tire friction with a road surface, generating temperature and pressure measurement data having the tire position identification information and the measured pressure and temperature, and loading and transmitting the generated temperature and pressure measurement data on a wireless signal; in the receiver, detecting the temperature and pressure measurement data from the wireless signal, detecting the tire position identification information and the internal pressure and temperature from the wireless signal, calculating an instantaneous temperature slope and an instantaneous pressure value, comparing the calculated instantaneous temperature slope and instantaneous pressure value with the tire replacement temperature reference value and pressure reference value, respectively, and if any one of the calculated instantaneous temperature slope and instantaneous pressure value is greater than the tire replacement temperature reference value and pressure reference value, generating a warning signal for informing of tire replacement; and in the warning unit, receiving the warning signal and warning a driver.

It is to be understood that both the foregoing summary and the following detailed description of the present invention are merely exemplary and intended for explanatory purposes only.

### BRIEF DESCRIPTION OF THE DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 illustrates a construction of an apparatus for estimating a tire life according to the present invention;

FIG. 2 illustrates a construction of a transmitter of an apparatus for estimating a tire life according to the present invention; and

FIG. 3 is a flowchart illustrating a method for estimating a tire life according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts.

As a tire is used, it gets thin due to abrasion of its surface against a road surface. The thinned tire varies a temperature elevation versus time curve according to the abrasion against the road surface, and increases a variation of a pressure resulting from running. The present invention measures and monitors the temperature elevation curve and the variation of the pressure, determines a time of reaching a predetermined temperature elevation slope and a predetermined variation as a replacement time of a tire, and informs a driver of the replacement time of the tire.

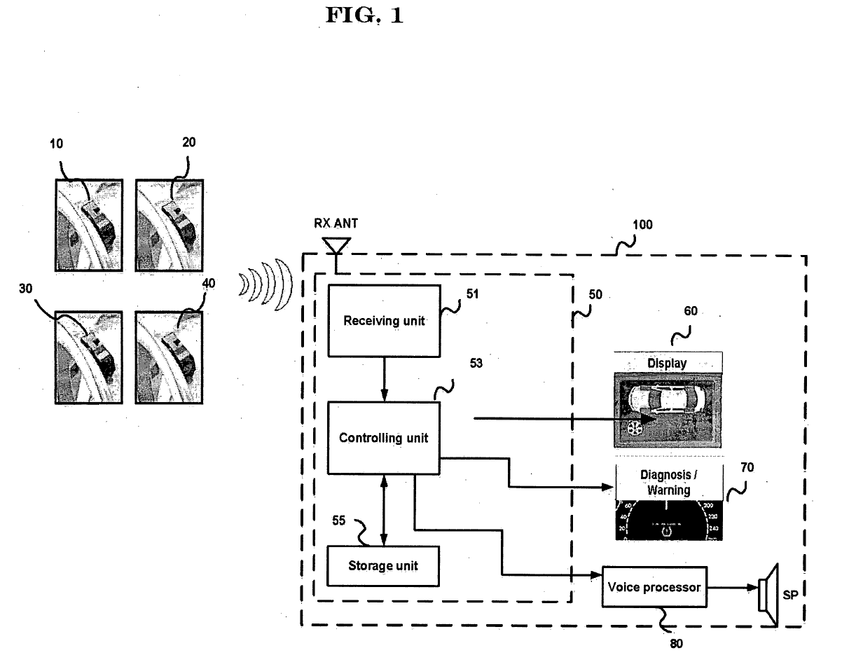

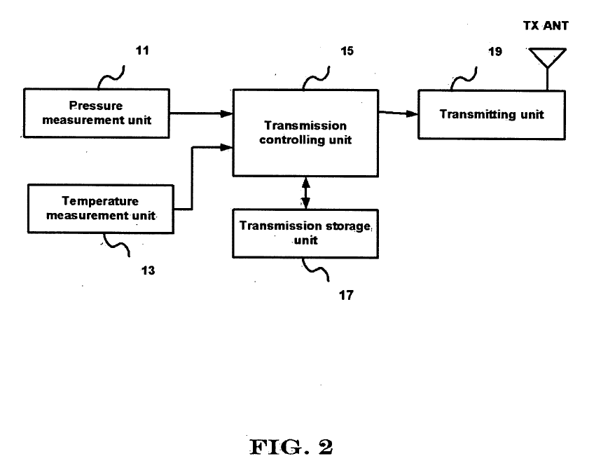

FIG. 1 illustrates a construction of an apparatus for estimating a tire life according to the present invention, and FIG. 2 illustrates a construction of a transmitter of the apparatus for estimating the tire life according to the present invention.

Hereinafter, a construction and an operation of the apparatus for estimating the tire life according to the present invention will be described with reference to FIGS. 1 and 2.

The inventive apparatus includes four transmitters, that is, first, second, third and fourth transmitters 10, 20, 30, and 40 disposed at rims of wheels of the car tires, respectively; and a main body 100 for receiving and processing wireless signals from the transmitters 10, 20, 30, and 40.

The transmitter includes a timer (not shown) for counting a time. The transmitter stores tire position identification information to allow the main body 100 to identify tire positions, that is, a front and left tire, a front and right tire, a rear and left tire, and a rear and right tire, and transmits the tire position identification information included in the wireless signal. Or, in another method, the transmitter can also allow the main body 100 to identify a transmission channel of the wireless signal from different fixed channels.

As shown in FIG. 2, each of the transmitters includes a pressure measurement unit 11, a temperature measurement unit 13, a transmission controller 15, a transmission storage unit 17, a transmitting unit 19, and a transmission antenna (TX ANT).

The pressure measurement unit 11 measures an internal pressure of the tire, and outputs a value of the measured pressure to the transmission controller 15.

The temperature measurement unit 13 measures an internal temperature of the tire, and outputs a value of the measured temperature to the transmission controller 15.

The transmission storage unit 17 stores the tire position identification information for identifying the tire positions, and stores a control program necessary for transmission. Or, the transmission storage unit 17 can store information on the fixed channel different from the channels allocated to other tires, in order to identify the tire equipped with the corresponding transmitter from other tires.

The transmitting unit 19 loads inputted data on the wireless signal, and transmits the loaded input data through the transmission antenna (TX ANT) under the control of the transmission controller 15.

The transmission controller 15 controls a general operation of the transmitter. In particular, the transmission controller 15 receives the measured pressure and temperature values from the pressure measurement unit 11 and the temperature measurement unit 13, reads the tire position identification information from the transmission storage unit 17, generates temperature and pressure measurement data by the measured temperature and pressure values, and outputs the generated temperature and pressure measurement data to the transmitter 19. In case where the transmission storage unit 17 has the information on the fixed channel different from the channels allocated to other tires, in order to identify the tire equipped with the corresponding transmitter from other tires, and the tire positions are identified by the wireless channel, the transmission controller 15 does not allow the tire position identification information to be included in the temperature and pressure measurement data, and controls the transmitting unit 19 to transmit the temperature and pressure measurement data over the corresponding channel.

The main body 100 includes a receiver 50, a first warning unit 60, a second warning unit 70, and a third warning unit 80.

The receiver 50 includes a receiving unit 51 for receiving the wireless signal and cyclically detecting the temperature and pressure measurement data from the received wireless signal under a predetermined control; a storage unit 55 for storing tire replacement temperature reference value (ΔTₛₗₒₚ) and pressure reference value (MaxΔP); a controlling unit 53 internally including a timer (not shown) for counting a time, and controlling the receiving unit 51 to cyclically receive the temperature and pressure measurement data, detecting tire position identification information and tire internal pressure and temperature information from the temperature and pressure measurement data to calculate an instantaneous temperature slope and an instantaneous pressure value, comparing the calculated instantaneous temperature slope and instantaneous pressure value with the tire replacement temperature reference and pressure reference values, and if any one of the calculated instantaneous temperature slope and instantaneous pressure value is greater than the tire replacement temperature reference and pressure reference values, generating a warning signal for informing of tire replacement. The instantaneous temperature slope (Tₛₗₒₚ) and instantaneous pressure value (Pₛₗₒₚ), that is, a variation of the temperature and pressure depending on a variation of the time is calculated in Equation 1 below:
Tₛₗₒₚ=ΔT/Δt
Pₛₗₒₚ=ΔP/Δt [Equation 1]
where,
ΔT: a difference (T2−T1) between a temperature of T1 measured at time of t1 and a temperature of T2 measured at time of t2,
Δt: t2−t1, and
ΔP: a difference (P2−P1) between a pressure of P1 measured at the time of t1 and a pressure of P2 measured at the time of t2.

The tire replacement temperature reference value (ΔTₛₗₒₚ) and pressure reference value (MaxΔP) are statistically obtained through an experiment.

In case where the tire position identification information for identifying the tire position is not used, the storage unit 55 should store each position of the transmitters and the fixed wireless channel information mapped to each position of the transmitters in order to identify the tire position by the wireless channel. The controlling unit 53 should control the receiving unit 51 depending on the channel information to monitor whether or not the wireless channel of each transmitter receives the wireless signal. The temperature and pressure values received under the control should be identified and managed at each transmitter.

The controlling unit 53 can allow the tire position identification information to be included in the warning signal.

The first warning unit 60 is a liquid crystal display (LCD), and receives the warning signal from the controlling unit 53 and displays a tire replacement time in a text and/or graphic form. In case where the controlling unit 53 outputs the tire position identification information together with the warning signal, the first warning unit 60 can display the position of the tire to be replaced in the text and/or graphic form.

The second warning unit 70 receives the warning signal from the controlling unit 53, flickers a tire replacement warning light, and informs a user of end of the tire life.

The fourth warning unit 80 receives the warning signal, and informs the user of the tire replacement by voice through a speaker (SP). The fourth warning unit 80 is a voice processor, and should store tire replacement voice data for informing the user of the tire replacement time by voice and converts the replacement voice data into an analogous signal. The tire replacement voice data can be also stored in the storage unit 55. In this case, the voice processor 80 can also receive, process, and output the tire replacement voice data by voice under the control of the controlling unit 53.

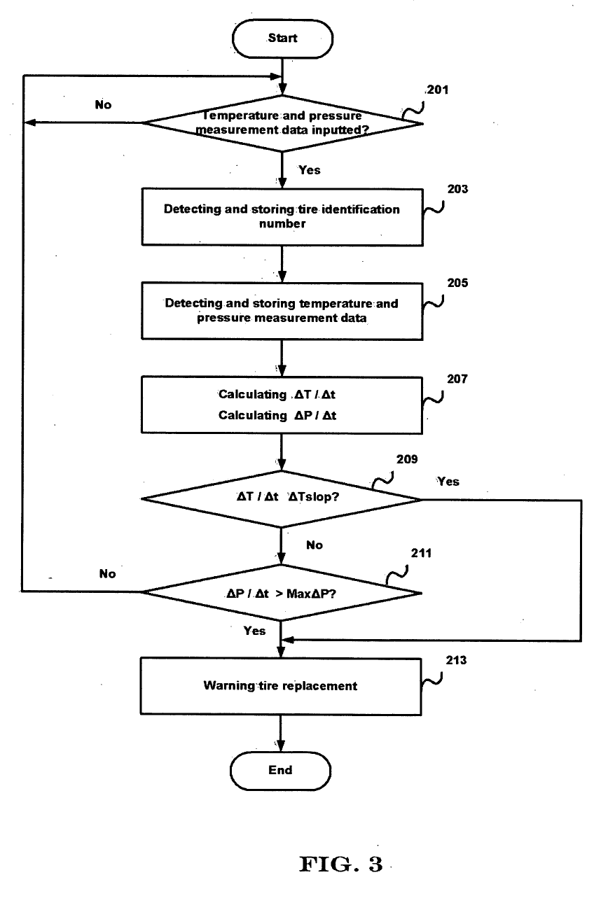

FIG. 3 is a flowchart illustrating a method for estimating the tire life according to the present invention. Hereinafter, the method for estimating the tire life will be described with reference to FIG. 3.

First, each of the transmitters loads the temperature and pressure measurement data on the wireless signal, and transmits the loaded temperature and pressure measurement data at a predetermined cycle.

Then, the controlling unit 53 of the receiver 50 determines whether or not the temperature and pressure measurement data is received from the receiving unit 51 in Step 201. Upon reception of the temperature and pressure measurement data in the Step 201, the controlling unit 53 detects a tire identification number from the temperature and pressure measurement data and stores the detected tire identification number in Step 203. In case where the tire position is identified by the wireless channel, in the Step 203, the wireless channel for receiving the temperature and pressure measurement data should be detected and a position of the transmitter using the detected wireless channel should be detected from the storage unit 55 instead of detecting and storing the tire identification number.

After that, the controlling unit 53 detects and stores the temperature and pressure values in Step 205. Upon detection and storage of the temperature and pressure data, the controller 53 calculates the instantaneous temperature slope (Tₛₗₒₚ) and the instantaneous pressure value (Pₛₗₒₚ) by the Equation 1 in Step 207.

Upon calculation of the instantaneous temperature slope (Tₛₗₒₚ) and the instantaneous pressure value (Pₛₗₒₚ) in the Step 207, the controlling unit 53 compares and determines whether or not the instantaneous temperature slope (Tₛₗₒₚ) is greater than the tire replacement temperature reference value (ΔTₛₗₒₚ) stored in the storage unit 55 in Step 209. If it is determined to be greater as the comparison result in the Step 209, the controlling unit 53 generates a tire replacement warning signal in Step 213. The first warning unit 60, the second warning unit 70, and/or the third warning unit 80 receive/receives the warning signal, and inform/informs the user of the end of the tire life.

On the contrary, if it is determined that the instantaneous temperature slope (Tₛₗₒₚ) is less than the tire replacement temperature reference value (ΔTₛₗₒₚ) in the Step 209, the controlling unit 53 determines whether or not the instantaneous pressure value (Pₛₗₒₚ) is greater than the tire replacement pressure reference value (MaxΔP) in Step 211. If it is determined that the instantaneous pressure value (Pₛₗₒₚ) is greater than the tire replacement pressure reference value (MaxΔP) in the Step 211, the controlling unit 53 generates and outputs the tire replacement warning signal to the warning units in Step 213. Otherwise, the controlling unit 53 returns to and repeats the Step 201.

As described above, the present invention has an advantage in that the tire replacement cycle having been checked using only person's naked eyes is informed the user using the temperature and the pressure, thereby allowing the user not to need to pay attention to a tire replacement cycle one by one.

Further, the present invention has an advantage of informing of the tire replacement cycle, thereby reducing a danger of accident resulting from an inappropriate use of the tire.

While the present invention has been described with reference to exemplary embodiments thereof, it will be apparent to those skilled in the art that various modifications can be made therein without departing from the spirit and scope of the invention as defined by the appended claims and their equivalents.

What is claimed is:

1. An apparatus for estimating a tire life, the apparatus comprising:
a transmitter for storing tire position identification information, measuring an internal pressure of a tire resulting from running of a vehicle and an internal temperature of the tire resulting from a tire friction with a road surface, and transmitting the measured internal pressure and temperature together with the tire position identification information;
a receiver for storing tire replacement temperature reference value and pressure reference value, detecting and comparing the tire position identification information and the internal pressure and temperature received from the transmitter, with the tire replacement temperature reference value and pressure reference value, and if any one of the tire internal pressure and temperature is greater than the tire replacement temperature reference value and pressure reference value, generating a warning signal for informing of tire replacement; and
a warning unit for receiving the warning signal and warning a driver.

2. The apparatus according to claim 1, wherein the transmitter comprises:
a transmission storage unit for storing the tire position identification information;
a pressure measurement unit for measuring the internal pressure of the tire;
a temperature measurement unit for measuring the internal temperature of the tire;
a transmitting unit for loading and transmitting the tire position identification information and the tire internal pressure and temperature on a wireless signal under a predetermined control; and
a transmission controlling unit for receiving the tire internal pressure and temperature measured sequentially at a predetermined time cycle, and outputting the received tire internal pressure and temperature together with the tire position identification information, to the transmitting unit.

3. The apparatus according to claim 1, wherein the transmitter is mounted at a rim of a tire wheel.

4. The apparatus according to claim 1, wherein the receiver comprises:
a receiving unit for receiving a wireless signal and cyclically detecting the tire position identification information and the tire internal pressure and temperature from the wireless signal, under a predetermined control;
a storage unit for storing the tire replacement temperature reference value and pressure reference value; and
a controlling unit for controlling the receiving unit to receive the tire position identification information and the tire internal pressure and temperature, comparing the received tire position identification information and tire internal pressure and temperature with the tire replacement temperature reference value and pressure reference value, respectively, and if any one of the tire internal pressure and temperature is greater than the tire replacement temperature reference value and pressure reference value, generating the warning signal for informing of the tire replacement.

5. The apparatus according to claim 1, wherein the warning unit is a displaying unit for informing of a replacement time of the tire in a text or graphic form.

6. The apparatus according to claim 1, wherein the warning unit is a voice processor for informing of a replacement time of the tire by an audible sound.

7. The apparatus according to claim 1, wherein the warning unit is comprised of a displaying unit for informing of a replacement time of the tire in a text or graphic form, and a voice processor for informing of the replacement time of the tire by an audible sound.

8. The apparatus according to claim 4, wherein the controlling unit outputs the tire position identification information together with the warning signal, to the warning unit.

9. The apparatus according to claim 8, wherein the warning unit is a displaying unit for receiving the tire position identification information and the warning signal, and informing of a replacement time and a position of the tire to be replaced, in a text or graphic form.

10. The apparatus according to claim 8, wherein the warning unit is a voice processor for informing of a replacement time and a position of the tire by an audible sound.

11. The apparatus according to claim 8, wherein the warning unit is comprised of a displaying unit for informing of a replacement time and a position of the tire to be replaced, in a text or graphic form, and a voice processor for informing of the replacement time and the position of the tire by an audible sound.

12. An apparatus for estimating a tire life, the apparatus comprising:
a transmitter for storing tire position identification information, measuring an internal pressure of a tire resulting from running of a vehicle and an internal temperature of the tire resulting from a tire friction with a road surface, generating temperature and pressure measurement data having the tire position identification information and the measured pressure and temperature, and loading and transmitting the generated temperature and pressure measurement data on a wireless signal;
a receiver for storing tire replacement temperature reference value and pressure reference value, detecting the temperature and pressure measurement data from the wireless signal, detecting the tire position identification information and the internal pressure and temperature from the wireless signal, calculating an instantaneous temperature slope and an instantaneous pressure value, comparing the calculated instantaneous temperature slope and instantaneous pressure value with the tire replacement temperature reference value and pressure reference value, respectively, and if any one of the calculated instantaneous temperature slope and instantaneous pressure value is greater than the tire replacement temperature reference value and pressure reference value, generating a warning signal for informing of tire replacement; and
a warning unit for receiving the warning signal and warning a driver.

13. The apparatus according to claim 12, wherein the transmitter comprises:
a transmission storage unit for storing the tire position identification information;
a pressure measurement unit for measuring the internal pressure of the tire;
a temperature measurement unit for measuring the internal temperature of the tire;
a transmitting unit for loading and transmitting the predetermined temperature and pressure measurement data on the wireless signal; and
a transmission controlling unit for receiving the tire internal pressure and temperature measured sequentially at a predetermined time cycle, and generating and outputting the temperature and pressure measurement data having the tire position identification information and the tire internal pressure and temperature, to the transmitting unit.

14. The apparatus according to claim 12, wherein the transmitter is mounted at a rim of a tire wheel.

15. The apparatus according to claim 12, wherein the receiver comprises:
a receiving unit for receiving the wireless signal and cyclically detecting the temperature and pressure measurement data from the wireless signal, under a predetermined control;
a storage unit for storing the tire replacement temperature reference value and pressure reference value; and
a controlling unit for controlling the receiving unit to cyclically receive the temperature and pressure measurement data, detecting the tire position identification information and the tire internal pressure and temperature from the temperature and pressure measurement data, calculating an instantaneous temperature slope and an instantaneous pressure value, comparing the calculated instantaneous temperature slope and instantaneous pressure value with the tire replacement temperature reference value and pressure reference value, respectively, and if any one of the calculated instantaneous temperature slope and instantaneous pressure value is greater than the tire replacement temperature reference value and pressure reference value, generating the warning signal for informing of the tire replacement.

16. The apparatus according to claim 12, wherein the warning unit is a displaying unit for informing of a replacement time of the tire in a text or graphic form.

17. The apparatus according to claim 12, wherein the warning unit is a voice processor for informing of a replacement time of the tire by an audible sound.

18. The apparatus according to claim 12, wherein the warning unit is comprised of a displaying unit for informing of a replacement time of the tire in a text or graphic form, and a voice processor for informing of the replacement time of the tire by an audible sound.

19. The apparatus according to claim 15, wherein the controlling unit outputs the tire position identification information together with the warning signal, to the warning unit.

20. The apparatus according to claim 19, wherein the warning unit is a displaying unit for receiving the tire position identification information and the warning signal, and informing of a replacement time and a position of the tire to be replaced, in a text or graphic form.

21. The apparatus according to claim 19, wherein the warning unit is a voice processor for informing of a replacement time and a position of the tire by an audible sound.

22. The apparatus according to claim 19, wherein the warning unit is comprised of a displaying unit for informing of a replacement time and a position of the tire to be replaced, in a text or graphic form, and a voice processor for informing of the replacement time and the position of the tire by an audible sound.

23. A method for estimating a tire life in a tire-life estimating apparatus having a transmitter having a transmission storage unit for storing tire position identification information, a receiver having a storage unit for storing tire replacement temperature reference value and pressure reference value, and a warning unit for warning a replacement time of a tire, the method comprising the steps of:
in the transmitter, measuring an internal pressure of a tire resulting from running of a vehicle and an internal temperature of the tire resulting from a tire friction with a road surface, and transmitting the measured internal pressure and temperature together with the tire position identification information;
in the receiver, detecting and comparing the tire position identification information and the internal pressure and temperature received from the transmitter, with the tire replacement temperature reference value and pressure reference value, and if any one of the tire internal pressure and temperature is greater than the tire replacement temperature reference value and pressure reference value, generating a warning signal for informing of tire replacement;
in the warning unit, receiving the warning signal and warning a driver.

24. A method for estimating a tire life in a tire-life estimating apparatus having a transmitter having a transmission storage unit for storing tire position identification information, a receiver having a storage unit for storing tire replacement temperature reference value and pressure reference value, and a warning unit for warning a replacement time of a tire, the method comprising the steps of:
in the transmitter, measuring an internal pressure of a tire resulting from running of a vehicle and an internal temperature of the tire resulting from a tire friction with a road surface, generating temperature and pressure measurement data having the tire position identification information and the measured pressure and temperature, and loading and transmitting the generated temperature and pressure measurement data on a wireless signal;
in the receiver, detecting the temperature and pressure measurement data from the wireless signal, detecting the tire position identification information and the internal pressure and temperature from the wireless signal, calculating an instantaneous temperature slope and an instantaneous pressure value, comparing the calculated instantaneous temperature slope and instantaneous pressure value with the tire replacement temperature reference value and pressure reference value, respectively, and if any one of the calculated instantaneous temperature slope and instantaneous pressure value is greater than the tire replacement temperature reference value and pressure reference value, generating a warning signal for informing of tire replacement; and
in the warning unit, receiving the warning signal and warning a driver.

25. The method according to claim 24, wherein the warning unit informs of a replacement time of the tire in a text or graphic form.

26. The method according to claim 24, wherein the warning unit informs of a replacement time of the tire by an audible sound.

27. The method according to claim 24, further comprising the step of: outputting the tire position identification information from a controlling unit to the warning unit.

28. The method according to claim 27, wherein the warning unit receives the tire position identification information and the warning signal, and informs of a replacement time and a position of the tire to be replaced, in a text or graphic form.

29. The method according to claim 27, wherein the warning unit informs of a replacement time and a position of the tire by an audible sound.
